(19) United States
(12) Patent Application Publication
(10) Pub. No.: US 2003/0142282 A1
(43) Pub. Date: Jul. 31, 2003

(54) Pattern forming method

(75) Inventor: Masashi Fujimoto, Kanagawa (JP)

Correspondence Address: YOUNG & THOMPSON, 745 SOUTH 23RD STREET 2ND FLOOR, ARLINGTON, VA, 22202

(73) Assignee: NEC ELECTRONICS CORPORATION, KANAGAWA (JP)

(21) Appl. No.: 10/352,040

(22) Filed: Jan. 28, 2003

(30) Foreign Application Priority Data
Jan. 30, 2002 (JP) 2002-021183

(51) Int. Cl. G03B 27/52

(52) U.S. Cl. 355/55; 355/52; 355/53; 355/77

(57) ABSTRACT

A pattern forming method of the invention for transferring a pattern on a photo-mask onto a photo-sensitive resin film on a substrate using a scan-projection exposure method includes the steps of:

scanning the photo-mask and the substrate in synchronization with each other; and

exposing the photo-sensitive resin film as consecutively correcting an aberration which occurs in a projection optical system which is positioned between the photo-mask and the substrate while scanning the photo-mask.

### BACKGROUND OF THE INVENTION

1. Field of the Invention

The invention relates generally to a pattern forming method and, more particularly to, a method for forming a fine pattern in a photolithographic step of manufacturing, in particular, a semiconductor device.

2. Description of the Related Art

Recently, with increasing speed and integration density of a semiconductor device, it has been more and more necessary to reduce pattern dimensions, which has led to discussion of a variety of ultra-resolving techniques related to a technology for transferring a pattern on a photo-mask (reticle) onto a photo-sensitive resin film such as a photo-resist film by utilizing a reduction-projection exposure method by use of an exposure apparatus. Among these is there present a deformational radiation method (for example, ring-shaped radiation) which represents a technique for devising an optical system of the exposure apparatus. Furthermore, as a technique for devising a mask are there present a method of using an auxiliary pattern, a method of using a phase-shift layer (which is proposed in SPIE VOL. 1463, Optical Laser Micro-lithography IV (1991)), and a method of using a half-tone phase-shift layer, some of them are put to practical use. The invention provides an ultra-resolving technology for further improving the above-mentioned method of using a half-tone phase-shift layer or a phase-shift layer.

In the above-mentioned reduction-projection exposure method, the resolution limit R of a transferred pattern is given by the Rayleigh's expression of R=kλ/NA and the depth of focus DOF is given by αλ=/NA². In these equations, λ is an exposure wavelength, NA is a numerical aperture of a projection lens, and k and α are constants which depend on lithographic steps including a resist work (resist development etc.).

Accordingly, to make the above-mentioned pattern dimensions finer, it is most effective to employ a method of reducing the exposure wavelength λ; in fact, presently, excimer laser beam emitted from KrF having λ=248 nm approximately is mainly used in the process of manufacturing a semiconductor device. By further employing the above-mentioned ultra-resolving technology besides this process, R=0.18 μm (180 nm) is realized at a practical level (a level of mass production of semiconductor devices).

Furthermore, there are being developed such techniques as to apply excimer laser beam emitted from ArF having λ=193 nm approximately or excimer laser beam emitted from F2 having λ=157 nm approximately.

In a pattern transferring technology by use of the above-mentioned reduction-projection exposure plus the above-mentioned conventional ultra-resolving technology, excimer laser beam emitted from ArF having λ=193 nm approximately is applied to realize R=0.13 μm (130 nm) at a practical level, so that it is expected that R=0.10 μm (100 nm) is realized at a practical level by applying excimer laser beam emitted from F2 having λ=157 nm approximately.

A MOSFET which is a semiconductor element, on the other hand, is confirmed to be operative as a transistor even in a case where it has a channel length of 0.05 μm and so indispensably requires for its application such pattern transferring techniques by use of reduction-projection exposure as to be able to realize a pattern dimension of 70 μm or so of a MOSFET gate electrode and an opening such as a contact hole or a via hole.

Presently, however, there is no light source (except for X-ray) available that can emit light having a wavelength shorter than that of excimer laser beam emitted from F2; in fact, in a pattern transferring technology by use of reduction-projection exposure, R=0.10 μm (100 nm) is considered to be a lower limit at a practical level. Therefore, the industries desire the developments of a new ultra-resolving technology.

Furthermore, in a field of pattern transfer, a variety of techniques are being discussed that use an electron in place of light. In this case, on principle, pattern transfer is possible at R=0.05 μm or less. This pattern transfer, however, cannot be expected so much in practical application because the present techniques have a low processing capability and suffer from a significant problem in mass production application.

### SUMMARY OF THE INVENTION

A pattern forming method of the invention for transferring a pattern on a photo-mask onto a photo-sensitive resin film on a substrate using a scan-projection exposure method comprises the steps of:

scanning the photo-mask and the substrate in synchronization with each other; and

exposing the photo-sensitive resin film as consecutively correcting an aberration which occurs in an optical system interposed between the photo-mask and the substrate while scanning the photo-mask.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a schematic diagram of an exposure apparatus for explaining a first embodiment of the invention;

FIG. 2 is a schematic diagram of an aberration correction region for explaining the first embodiment of the invention;

FIG. 3 is a plan view of an exposure slit over a wafer for explaining the first embodiment of the invention;

FIG. 4 is a graph of an aberration distribution in the exposure slit over a wafer for explaining the first embodiment of the invention;

FIG. 5 is a schematic diagram of a wafer region for explaining the first embodiment of the invention;

FIG. 6 is a graph showing a focus offset variation of a wafer for explaining the first embodiment of the invention;

FIG. 7 is a schematic cross-sectional view of a reticle for explaining the first embodiment of the invention;

FIG. 8 is a graph of a light intensity distribution of an opening pattern for explaining an effect in the first embodiment of the invention;

FIG. 9 is a graph of dependency of an optical contrast on a focus offset using a corrected aberration as a parameter for explaining an action of the first embodiment of the invention;

FIGS. 10A and 10B are graphs for explaining the effect of the first embodiment of the invention;

FIG. 11 is a schematic diagram of an aberration correction region for explaining a second embodiment of the invention;

FIG. 12 is a plan view of an exposure slit over a wafer for explaining the second embodiment of the invention;

FIG. 13 is a schematic diagram for explaining the second embodiment of the invention;

FIG. 14 is a schematic diagram of an aberration correction region for explaining a variant of the second embodiment of the invention; and

FIG. 15 is a graph for showing dependency of an (optical) maximum contrast on a corrected aberration for explaining the second embodiment of the invention.

### DETAILED DESCRIPTION OF THE INVENTION

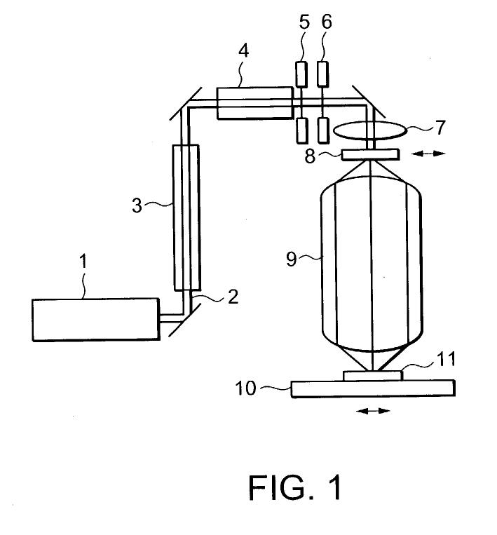

The following will describe a first embodiment of the invention with reference to FIGS. 1-6. FIG. 1 is a schematic diagram of an exposure apparatus using KrF excimer laser beam. This exposure apparatus is of a step-and-scan type. First, operations etc. of this exposure apparatus are described in general.

As shown in FIG. 1, KrF excimer laser beam 2 emitted from a light source 1 passes through a beam formation optical system 3, a radiation optical system 4, a radiation diaphragm 5, and a field diaphragm 6 to be transformed into slit-shaped radiation light flux and then passes through a condenser lens 7 to be transformed into parallel light and is applied onto a reticle 8. It is to be noted that the reticle 8 is mounted on a holder (not shown).

The KrF excimer laser beam 2, which is now slit-shaped radiation light flux, passes through a projection lens 9 having pattern information on the reticle 8 and constituting a projection optical system, to be projected onto the surface of a wafer 11, which is a substrate mounted on a stage 10. Typically, however, the radiation light flux (KrF excimer laser beam 2) passes through the reticle 8 and then gets a spherical aberration at the above-mentioned projection optical system. In this specification, a region which lies in a photo-resist film on the surface of the wafer 11 and onto which the above-mentioned slit-shaped radiation light flux is applied is referred to as an exposure slit as described later.

When transferring a pattern on the reticle 8 onto the photo-resist film on the wafer 11, as shown by arrows in FIG. 1, the reticle 8 and the wafer 11 are scanned in synchronization with each other under the radiation region of the slit-shaped radiation light flux at a speed that corresponds to a projection reduction ratio, to form an optical image of the pattern on the wafer 11, thus transferring the pattern onto an entire semiconductor chip.

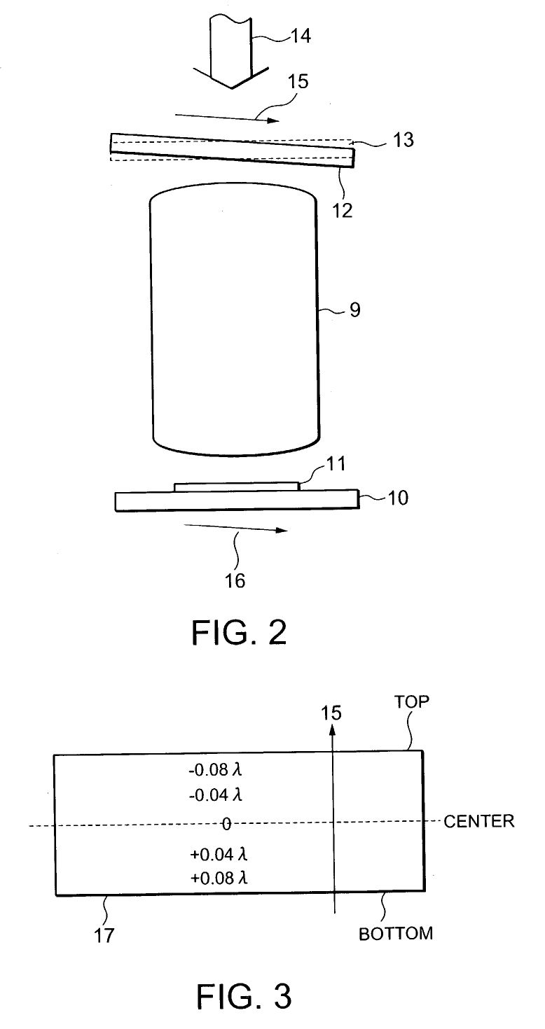

By the invention, in the above-mentioned exposure apparatus, as shown in FIG. 2, the reticle is arranged as an inclined reticle 12. That is, with respect to a reticle-side tele-centric face 13 which is arranged horizontally in a general case, by the invention, the reticle 12 is inclined in a predetermined direction. Then, such slit-shaped radiation light flux 14 as described above is applied onto the inclined reticle 12, to transfer and form an image of the pattern information on the inclined 12 via the projection lens 9 on the surface of the wafer 11 mounted on the stage 10.

In this case, as shown in FIG. 2, the inclined reticle 12 is scanned at a constant speed in a reticle scanning direction 15, in which it is inclined. At the same time, the stage 10 is also scanned at the constant speed in a wafer stage travelling direction 16 in synchronization with the scanning of the inclined reticle 12.

Then, the pattern information on the inclined reticle 12 having a half-tone phase-shift layer is converted into diffracted light, passes through the projection lens 9, and is transferred in focus onto the photo-resist film on the wafer 11. In this case, if the reticle is inclined in the predetermined direction as described above, the light which carries the pattern information on the reticle has an aberration due to a difference in optical path. This is the above-mentioned corrected aberration.

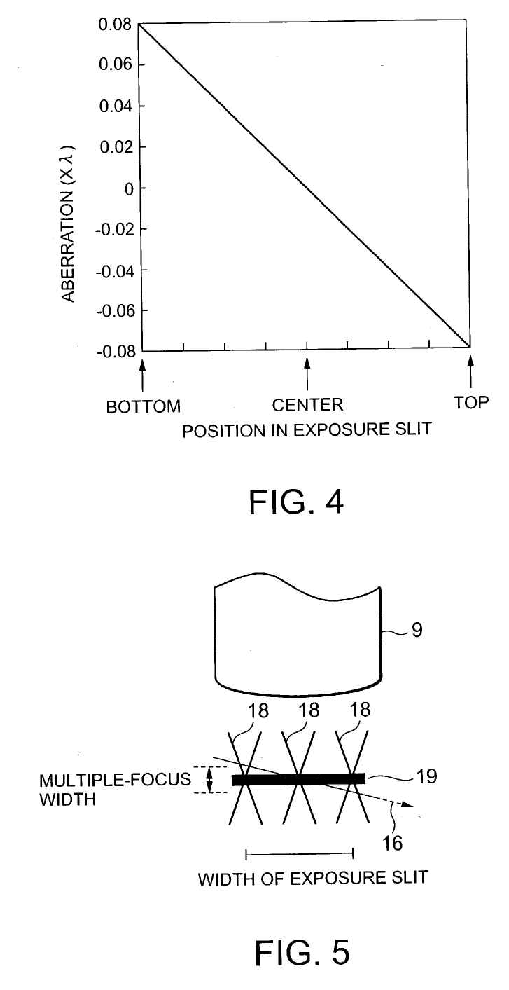

The following will describe an aberration which occurs when the above-mentioned reticle 12 is inclined, with reference to FIGS. 3 and 4. Such FIGS. 3 and 4 show a distribution of the above-mentioned aberration within an exposure slit 17 in which a radiation region is formed when the above-mentioned slit-shaped radiation light flux 14 is projected onto the wafer 11. As shown in FIG. 3, the aberration is distributed at +0.08λ, 0.04λ, 0, −0.04λ, and −0.08λ from the bottom to the top in this order. Furthermore, the magnitude of the aberration varies linearly as shown in FIG. 4. In this case, λ indicates an exposure wavelength. In FIG. 3, the above-mentioned scanning direction of the inclined reticle 12 is indicated by the reticle scanning direction 15. In this invention, preferably the aberration is distributed roughly symmetrical between positive and negative halves as disposed symmetric with respect to the center line with the value thereof being roughly 0 at the center of the exposure slit 17.

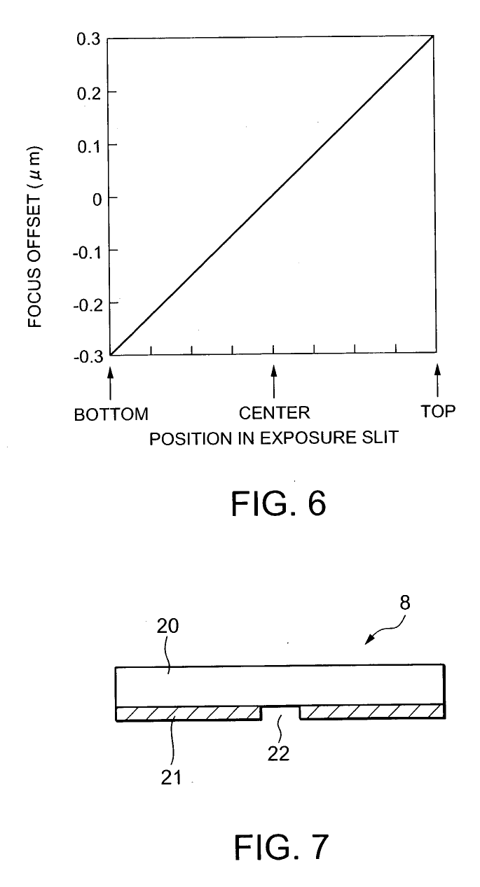

The following will describe the above-mentioned wafer stage travelling direction 16 with reference to FIGS. 5 and 6. As described above, geometrical optics-wise, the pattern information on the inclined reticle 12 passes through the projection lens 9 to be converted into focused light 18 and is formed as an image of an optical pattern on an image formation face 19. Taking into account wave optics, strictly speaking, the image formation face has some width, so that such a depth of focus (DOF) as described above is generated; in the following, however, description is made mainly geometrical optics-wise for easy understanding.

The width of the exposure slit shown in FIG. 5 refers to a width between the bottom and the top of the exposure slit 17 shown in FIG. 3, measuring 7 mm or so. The surface of the wafer 11 is scanned in the wafer stage travelling direction 16 shown in FIG. 5 in synchronization with the inclined reticle 12 as it is scanned in the reticle scanning direction 15. In this case, a focus offset to be described later refers to a distance by which the position of the wafer face is separated from the image formation face 19, coming in negative in value when the line indicating the wafer stage travelling direction 16 is above the image formation face 19 in FIG. 5 and positive when it is below the image formation face 19.

FIG. 6 shows a relationship between a focus offset described above and a corrected aberration. As can be seen from a focus offset shown in FIG. 6, since the best focus varies roughly linearly as about −0.3 μm, 0 μm, and about +0.3 μm at the bottom, the center, and the top respectively in the exposure slit 17, by consecutively changing the optical axial (z-directional) height of the stage 10 in agreement with this variation of the best focus during scan-exposure operation, a pattern image is formed at the best focus always. This can be realized easily by, as shown in FIG. 5, inclining the wafer stage travelling direction 16 with respect to the image formation face (scan multiple-focus exposure). In such a manner, a pattern on the reticle is subjected to multiple-focus exposure within a multiple-focus width as shown in FIG. 5.

In such a manner, by the invention, the lower limit of the pattern resolution is extended downward, so that the image formation performance such as a resolution limit of a pattern for forming a hole such as a through hole or a via hole, a mask linearity, and a mask dimension error margin is improved by 20-30%. Accordingly, it is possible to easily achieve finer patterning, a higher integration density, a higher speed, and a higher yield of semiconductor devices at a practical level.

The following will describe actions and effects of the invention with reference to FIGS. 7-10. FIG. 7 shows an example of a construction of the reticle 8. In the reticle 8, on the surface of a transparent substrate 20 is there formed a half-tone phase-shift layer 21 made of, for example, tungsten silicide (WSi), on which is there formed an opening pattern 22. In this example, the opening pattern 22 is isolated, having an aperture of 0.2 μm×4. It is to be noted that the transmission factor of KrF excimer laser beam of the half-tone phase-shift layer 21 is 5-10%.

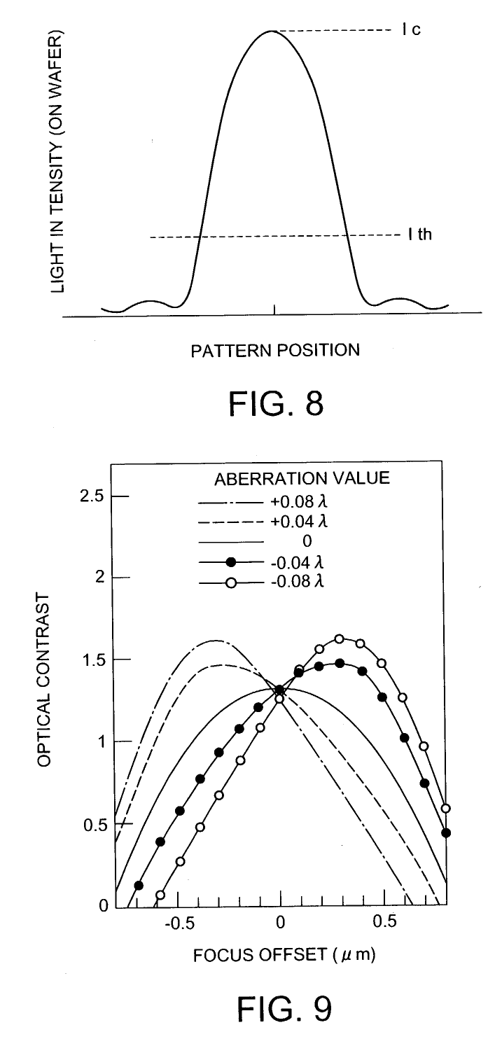

FIG. 8 shows a light intensity distribution of such an optical pattern as shown in FIG. 7 obtained when this pattern is projected as reduced (¼) onto the wafer 11 through the above-mentioned exposure apparatus. As shown in the distribution of FIG. 8, the light intensity hits the peak at a point that corresponds to the center of the opening pattern 22 and decreases rapidly as it gets near the end of the opening pattern 22. In this case, the peak intensity is represented by Ic. Furthermore, a response-threshold light intensity of the photo-resist film is represented by Ith, thus defining the optical contrast=(Ic−Ith)/Ith.

FIG. 9 is a graph for showing a relationship between the above-mentioned optical contrast and a focus offset, using the above-mentioned aberration as a parameter. As can be seen from FIG. 9, in a case where an aberration is +0.08λ, if a focus offset is set to about −0.3 μm as shown in FIG. 6 and exposure is performed, an optical contrast can be obtained which is higher than that in a case of no aberration (an aberration is 0 in value). Similarly, in a case where an aberration is −0.08λ, if a focus offset is set to about +0.3 μm and exposure is performed, an optical contrast can be obtained which is higher than that in a case of no aberration (an aberration is 0 in value). The same tendency is obtained also when an aberration is +/−0.04λ. It is to be noted that the larger the absolute value of an aberration is, the more is improved an optical contrast at the best focus. This is because at a certain focus a phase modulation action of a spherical aberration on the pupil surface works together with an effect of a half-tone phase-shift layer to thereby strengthen the phase shift effect. In this case, however, in addition to a decrease in the above-mentioned total depth of focus between different pattern dimensions, a pattern-dimension vs. defocus characteristic exhibits a strong un-symmetry as well known, so that such a method cannot simply be used as to give a large aberration in a projection optical system.

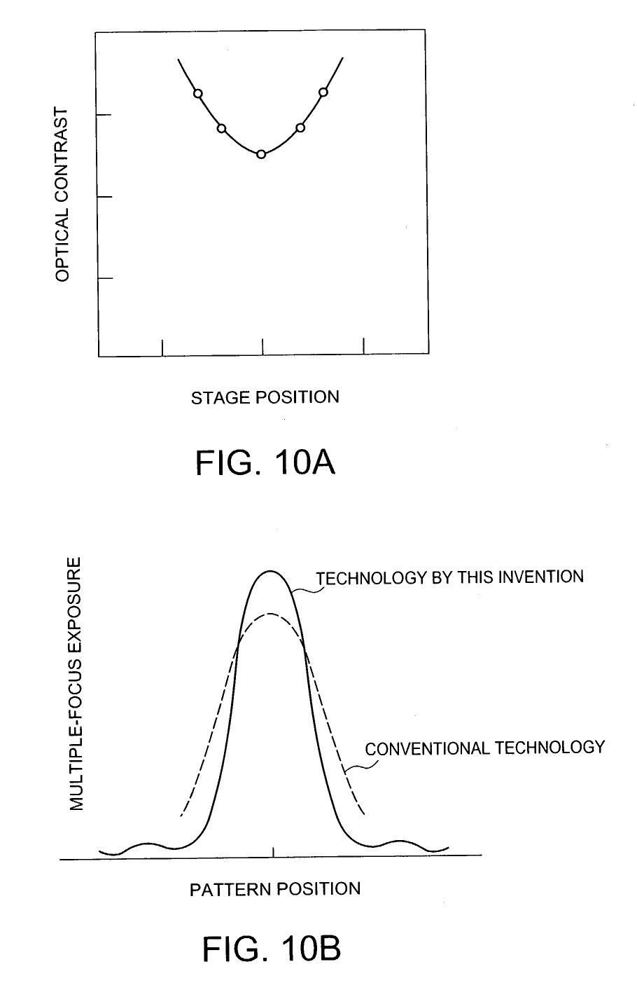

In the first embodiment, as described above, the best focus is varied roughly linearly as about −0.3 μm, 0 μm, and +0.3 μm at the bottom, the center, and the top respectively of the exposure slit 17, so that by consecutively changing the position of the stage 10 of the wafer 11, that is, the optical axial height thereof in agreement with this variation of the best focus during scan-exposure operation, as shown in FIG. 10A, a pattern image is subjected to multiple-focus exposure at the best focus always. Then, a pattern image formed finally is an average of pattern images which consecutively change at the bottom, the center, and the top of the exposure slit. In terms of optical contrast shown in FIG. 9, a contrast given finally is an average of those of space images which change consecutively from a maximum of about 1.6, down to a minimum of about 1.3, and then up to a maximum of about 1.6 and so naturally higher than an optical contrast in the case of no aberration of about 1.3.

Thus, as shown in FIG. 10B, in a distribution of a multiple-exposure of a photo-resist film on the wafer 11, a peak exposure at a pattern position that corresponds to an aperture pattern on the reticle 8 becomes larger than that by the conventional technology. Furthermore, the distribution of a multiple-exposure becomes more steep than that by the conventional technology. This improves the image formation performance such as a resolution limit, a mask linearity, and a mask dimension error margin as described above. Furthermore, by the method according to the invention, aberrations are given symmetrically between positive and negative halves and, therefore, their effects are completely averaged, so that the defocus characteristic does not exhibit un-symmetry. Furthermore, no difference in best focus occurs between different pattern dimensions.

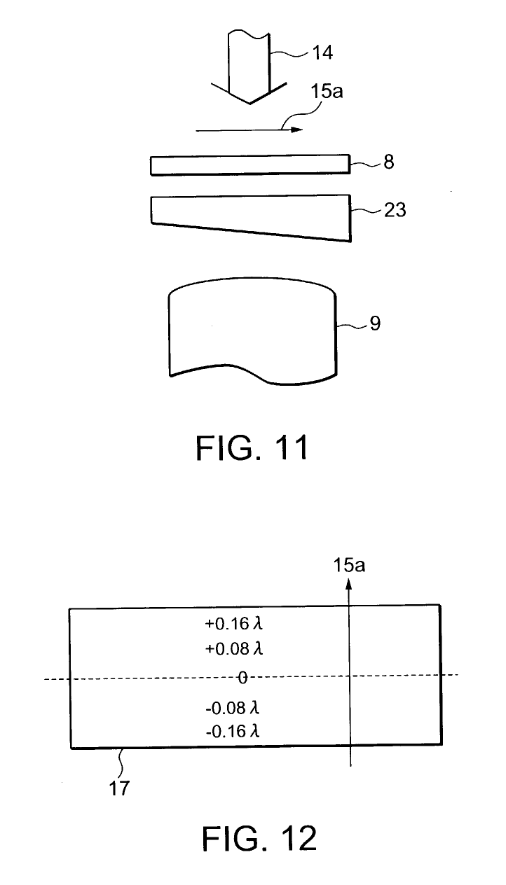

The following will describe a second embodiment of the invention with reference to FIGS. 11-15. Although the first embodiment has worked out a corrected aberration distribution by inclining the reticle stage with respect to an original tele-centric face along a scanning direction, a transparent plate may be interposed between the reticle and the projection lens to thereby provide a desired aberration distribution.

In this embodiment, in the above-mentioned exposure apparatus, as shown in FIG. 11, a reticle 8 is arranged horizontally as in the ordinary case. Then, between the reticle and a projection lens 9 is interposed an inclined transparent plate 23 as shown in FIG. 11. In this case, the inclined transparent plate 23 is made of quartz etc. and has an inclined face having a constant inclination angle.

In this configuration, as described with the first embodiment, slit-shaped radiation light flux 14 is applied onto the reticle 8, so that pattern information on the reticle 8 passes through the inclined transparent plate 23 and the projection lens 9 and is transferred onto the surface of a wafer 11 mounted on the stage 10 to be formed as an image thereon. Then, as shown in FIG. 11, the reticle 8 is scanned at a constant speed in a horizontal reticle scanning direction 15a. At the same time, the stage 10 is also scanned, for example at the constant speed, in a wafer stage travelling direction in synchronization with the scanning of the reticle 8.

Accordingly, the pattern information on the reticle 8 having a half-tone phase-shift layer is converted into diffracted light etc., which passes through the projection lens 9 and is transferred in focus onto a photo-resist film on the wafer 11. In this case, if the inclined transparent plate 23 is interposed as described above, the light which carries the pattern information on the reticle 8 has an aberration due to a difference in optical path.

The following will describe the aberration which occurs in such a case, with reference to FIG. 12. FIG. 12 shows a distribution of the above-mentioned aberration within an exposure slit 17 in which a radiation region is formed when the slit-shaped radiation light flux 14 is projected onto the wafer 11 as in the case shown in FIG. 3. As shown in FIG. 12, the aberration is distributed at −0.16λ, −0.08λ, 0, +0.08λ, and +0.16λ from the bottom to the top in this order. In FIG. 12, the above-mentioned scanning direction of the reticle 8 provides a reticle scanning direction 15a.

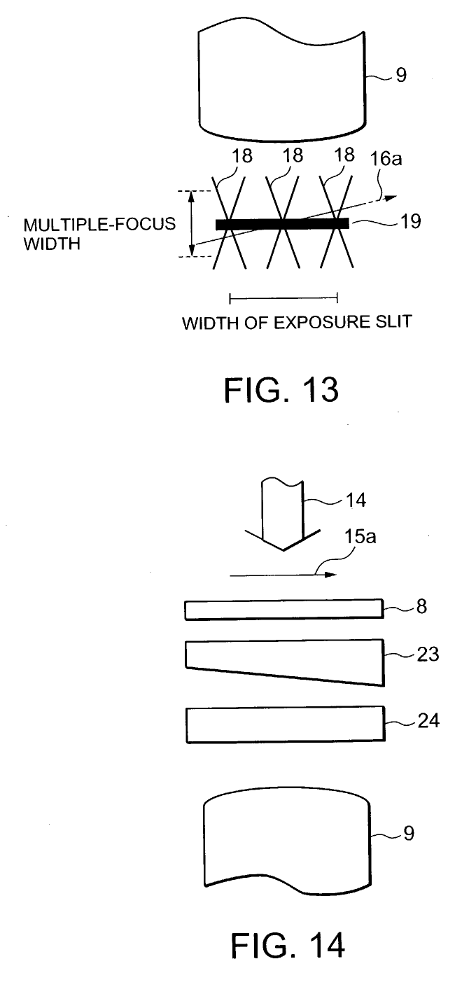

In this case, it provides a wafer stage travelling direction 16a as shown in FIG. 13. That is, geometrical optics-wise, the above-mentioned pattern information on the reticle 8 passes through the projection lens 9 to be converted into focused light 18 and is formed as an image on an image formation face 19. In FIG. 13, the width of the exposure slit refers to a width between the bottom and the top of the exposure slit 17 shown in FIG. 12. The surface of the wafer 11 is scanned along the wafer stage travelling direction 16a shown in FIG. 13 in synchronization with the reticle 8 as it is scanned in the reticle scanning direction 15a. In such a manner, as shown in FIG. 13, the pattern on the reticle is subjected to multiple-focus exposure within the multiple-focus width.

FIG. 14 shows a variant of the second embodiment. In FIG. 14, furthermore, an adjustment transparent plate 24 is interposed between the inclined transparent plate 23 and the projection lens 9 in a configuration shown in FIG. 11. By interposing this adjustment transparent plate 24, it is possible to adjust parallelism of the slit-shaped radiation light flux 14 after it has passed through the inclined transparent plate 23. In the configuration shown in FIG. 11, after having passed through the inclined transparent plate 23, the radiation light flux is deteriorated a little in parallelism. In this case, the wafer stage travelling direction is the same as that shown in FIG. 13.

In the above-mentioned second embodiment, a corrected aberration can be made larger than that in the case of the first embodiment. The second embodiment still has almost the same effects as those described with the first embodiment. That is, the image formation performance such as a resolution limit of a pattern for forming a hole such as a through hole or a via hole, a mask linearity, and a mask dimension error margin is improved by 40% or so, which is larger than by the first embodiment.

As described above, a major feature of the invention is that when exposing and transferring a pattern on a reticle onto a photo-resist film on a wafer, a predetermined aberration is added to optical information of the pattern on the reticle, so that a focus offset that corresponds to a resultant corrected aberration is provided to a position on the wafer to which the pattern is transferred.

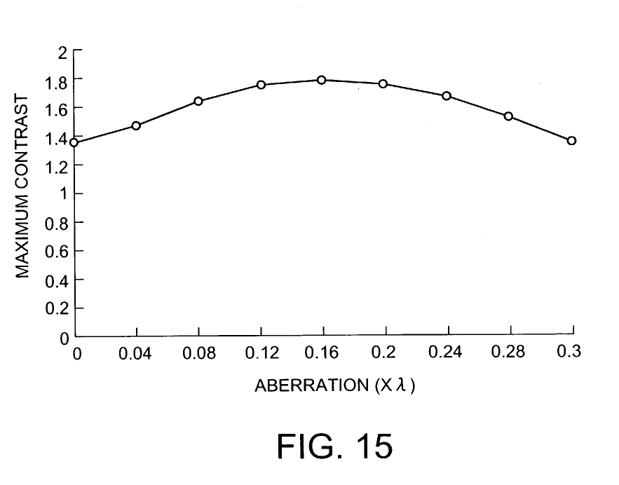

On the assumption described with the first embodiment, such an optical contrast as shown in FIG. 9 has been simulated. The results are shown in FIG. 15. In FIG. 15, its vertical axis represents an optical contrast peak as a maximum contrast. Its horizontal axis, on the other hand, represents the above-mentioned aberration. As can be seen from FIG. 15, the maximum contrast increases until the aberration increases to 0.16λ at which it hits the peak and, beyond it, decreases monotonously. This shows that the larger its value becomes, the larger effects has the above-mentioned aberration, persuading that the second embodiments has larger effects than the first embodiment. A specific quantity of the effects of intentionally adding an aberration in such a manner is dependent on an optical system of an exposure apparatus employed.

Although the above description has been made mainly on a case where KrF excimer laser beam is used in total-refraction reduction-projection exposure by means of a step-and-scan method. The invention, however, can be applied completely similarly also to a case of using ArF excimer laser beam or F2 excimer laser beam in exposure. Simulation thereon has come up with a result that by using F2 excimer laser beam in the invention, a 50-nm pattern can be transferred. It is to be noted that if a photo-mask is not scanned, the invention can be applied similarly to a stepper, which is of a step-and-repeat type.

It is also to be noted that the invention can be applied similarly to a case where a photo-mask pattern is transferred onto a photo-resist film on a substrate through projection exposure by use of a cata-dioptric system.

Furthermore, the invention is not limited in application to a case where an opening pattern is formed in the reticle made of a half-tone phase-shift layer. Besides, the method of the invention can be applied sufficiently to a trench pattern or an isolated line pattern of a gate electrode, to obtain the same effects. It is to be noted that the same effects can be obtained irrespective of whether the photo-resist film is of a positive type or a negative type.

The invention will provide the same effects even in a case of transfer of a pattern in which an ordinary phase-shift layer different from a half-tone phase-shift layer is formed on the reticle. In this case, however, the effects are deteriorated.

Furthermore, besides pattern transfer in manufacture of a semiconductor device, the invention can be applied to manufacture of an LCD or formation of a substrate related to high-density packaging.

Although, in the embodiments of the invention, means for correcting an aberration occurring in a projection optical system placed between a photo-mask and a substrate has been interposed between the photo-mask and the projection optical system, the invention is not limited thereto; in fact, the means may be provided at any other position.

Thus, the invention is not limited to the above-mentioned embodiments; in fact, its embodiments may be modified within a scope of the technological concept of the invention.

As described above, the invention features that when transferring, by projection exposure, a pattern on a photo-mask onto a photo-resist film on a wafer, a predetermined aberration is added to optical information of the pattern on the photo-mask, so that a focus offset that corresponds to a resultant corrected aberration is provided to a position on the wafer to which the pattern is transferred.

In such a manner, it is possible to extend the lower resolution limit downward by a simple method in a pattern transfer technology by means of projection exposure by use of light and also to apply the ultra-resolving technologies to mass production. The image formation performance such as a resolution limit of a pattern for forming a hole such as a through hole or a via hole, a mask linearity, and a mask dimension error margin is improved by 40%, thus making it possible to easily achieve finer patterning, a higher integration density, a higher speed, and a higher yield of semiconductor devices at a practical level.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. A pattern forming method for transferring a pattern on a photo-mask onto a photo-sensitive resin film on a substrate using a projection exposure method, the pattern forming method comprising the steps of:
correcting an aberration using correcting means for correcting an aberration which occurs in a projection optical system which is positioned between the photo-mask and the substrate and interposed between the photo-mask and the projection optical system; and
forming an image of the pattern on the photo-mask onto the photo-sensitive resin film.

2. The pattern forming method according to claim 1, wherein a position where the image of the pattern is formed is changed corresponding to the corrected aberration.

3. A pattern forming method for transferring a pattern on a photo-mask onto a photo-sensitive resin film on a substrate using a scan-projection exposure method, the pattern forming method comprising the steps of:
scanning the photo-mask and the substrate in synchronization with each other; and
exposing the photo-sensitive resin film as consecutively correcting an aberration which occurs in a projection optical system which is positioned between the photo-mask and the substrate while scanning the photo-mask.

4. The pattern forming method according to claim 3, wherein in the scanning, an optical axial position of the substrate with respect to a focal point of radiation light which has passed through the projection optical system is varied to thereby scan the substrate, thus performing multiple-focus exposure on the photo-sensitive resin film.

5. The pattern forming method according to claim 4, wherein the optical axial position of the substrate is varied in such a manner as to maximize an optical contrast of an optical pattern obtained by forming an image of the pattern present on the photo-mask.

6. The pattern forming method according to claim 3, wherein an aberration which is corrected during the scanning is in a linear relationship with an amount by which the photo-mask is scanned

7. The pattern forming method according to claim 3, wherein correction of an aberration which is performed together with the scanning is carried out by inclining the photo-mask with respect to a direction of the optical axis by a constant angle so that a scanning direction of the photo-mask may agree with an inclination direction of the photo-mask.

8. The pattern forming method according to claim 3, wherein correction of an aberration to be performed together with the scanning is carried out by interposing a transparent plate having an inclined face between the photo-mask and the projection optical system.

9. The pattern forming method according to claim 1 or 3, wherein the pattern on the photo-mask is formed in such a manner as to include a half-tone phase-shift layer.

10. The pattern forming method according to claim 9, wherein the pattern on the photo-mask is an isolated pattern.

11. The pattern forming method according to claim 10 wherein the pattern on the photo-mask is a pattern for forming an opening.
